(19) United States
(12) Patent Application Publication
(10) Pub. No.: US 2020/0234189 A1
(43) Pub. Date: Jul. 23, 2020

(54) TRANSFER LEARNING METHOD, AND LEARNING APPARATUS, AND RECORDING MEDIUM

(71) Applicant: FUJITSU LIMITED, Kawasaki-shi (JP)

(72) Inventor: MITSURU ODA, Setagaya (JP)

(73) Assignee: FUJITSU LIMITED, Kawasaki-shi (JP)

(21) Appl. No.: 16/741,805

(22) Filed: Jan. 14, 2020

(30) Foreign Application Priority Data
Jan. 17, 2019 (JP) 2019-006421

(51) Int. Cl. G06N 20/00

(52) U.S. Cl. CPC G06N 20/00

(57) ABSTRACT

A transfer learning method executed by a computer, the method includes: selecting learning data that satisfies a constraint identified from target learning data and source learning data; and extracting the selected learning data among the source learning data as transfer data to be used as the target learning data.

### CROSS-REFERENCE TO RELATED APPLICATION

This application is based upon and claims the benefit of priority of the prior Japanese Patent Application No. 2019-6421, filed on Jan. 17, 2019, the entire contents of which are incorporated herein by reference.

### FIELD

The embodiments discussed herein are related to transfer learning technology.

### BACKGROUND

In statistical machine learning technology using deep learning (DL) and the like, classifier learning is performed by supervised learning, but sufficient teacher data may not often be prepared. In light of the above situation, machine learning (transfer learning) that uses data from another region (source domain (SD)) as teacher data of a target region (target domain (TD)) has gained attention. The transfer learning is a learning method in which for example, in order to efficiently find effective hypotheses in a new (target) domain (task), knowledge learned in one or more different (source) domains is obtained and applied.

In the transfer learning, the source domain and the target domain are often assumed to be similar, but contrary to the assumption, the data distribution of the source domain and the target domain may differ greatly. In this case, when the source domain data is transferred to the target domain and transfer learning is performed in the target domain, a negative transfer occurs and learning accuracy deteriorates. The negative transfer refers to a phenomenon in which the performance of a classifier obtained by performing transfer learning is deteriorated, compared with that of a classifier that does not use transfer data.

In recent years, a clustering technique for adjusting a difference in data distribution between a source domain and a target domain is known. For example, transfer candidate data in the source domain is clustered by data characteristics, and the obtained clusters are sequentially subjected to trial machine learning along with the data in the target domain. The effectiveness of the cluster is evaluated from the result, and more effective transfer candidate data is used as transfer data until the required number is obtained.

For example, related techniques have been disclosed in Japanese Laid-open Patent Publication No. 2017-224156 and Japanese Laid-open Patent Publication No. 2018-022473.

### SUMMARY

According to an aspect of the embodiments, an apparatus includes: selecting learning data that satisfies a constraint identified from target learning data and source learning data; and extracting the selected learning data among the source learning data as transfer data to be used as the target learning data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an entire example of a learning apparatus according to a first embodiment;

FIG. 2 is a functional block diagram illustrating a functional configuration of the learning apparatus according to the first embodiment;

FIG. 3 is a diagram illustrating an example of information stored in a target data DB;

FIG. 4 is a diagram illustrating an example of information stored in a target knowledge DB;

FIG. 5 is a diagram illustrating an example of information stored in a source knowledge DB;

FIG. 6 is a diagram illustrating an entire example of transfer data extraction;

FIG. 7 is a diagram for explaining a premise of target knowledge and source knowledge;

FIG. 8 is a diagram for explaining generation of a target attestation;

FIG. 9 is a diagram for explaining generation of a source attestation;

FIG. 10 is a diagram for explaining detection of the attestations that form the pair between a target and a source;

FIG. 11 is a diagram for explaining detection of the same type of attestation in a source;

FIG. 12 is a diagram illustrating extraction of transfer data;

FIG. 13 is a flowchart illustrating a series of flow from transfer data extraction processing to learning processing;

FIG. 14 is a flowchart of a detailed flow of transfer data extraction processing according to a first embodiment;

FIG. 15 is a flowchart of a detailed flow of a configuration process of an attestation set according to the first embodiment;

FIG. 16 is a diagram illustrating an example of selecting a source from a plurality of knowledge sources; and

FIG. 17 is a diagram describing an example of a hardware configuration.

### DESCRIPTION OF EMBODIMENTS

In the related art, when the number of clusters is increased in order to suppress deterioration in learning accuracy, the number of times of trial machine learning operations increases, so that the processing time required for extracting transfer data is prolonged. When the number of clusters is reduced, the number of times of trial machine learning operations is reduced, and the processing time required for extracting transfer data is shortened, but the learning accuracy may deteriorate. As described above, in order to extract useful transfer data that may be expected to improve learning accuracy in a short time, both the number of dusters and the processing time has to be considered, and it is not easy for the user to handle the both.

Hereinafter, embodiments of a transfer learning method, a transfer learning program, and a learning apparatus disclosed in the present application are described in detail with reference to the drawings. It is noted that the present disclosure is not limited by the embodiments. Embodiments may be combined with each other as appropriate when there is no contradiction.

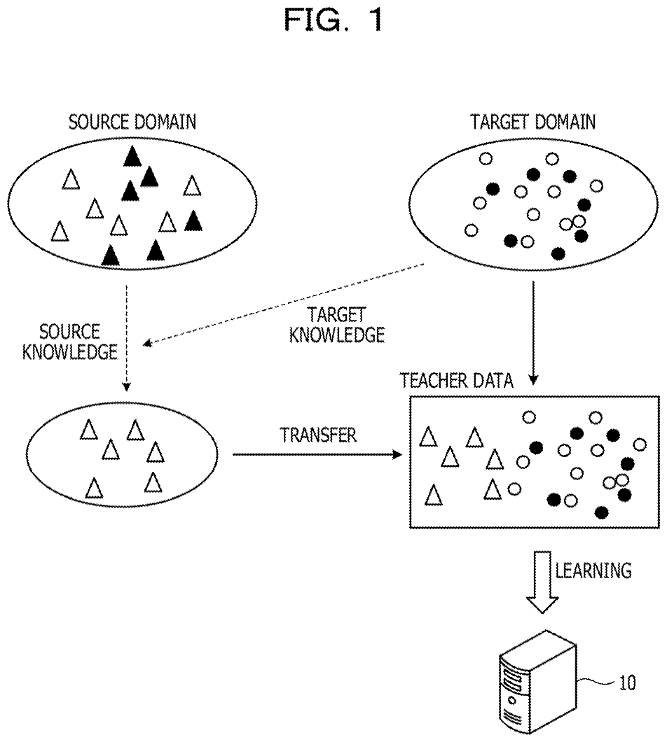

FIG. 1 is a diagram illustrating an entire example of a learning apparatus according to a first embodiment. A learning apparatus 10 illustrated in FIG. 1 is an example of a computer device that performs machine learning using teacher data with a label attached.

In recent years, systems storing human knowledge, such as linked open data (LOD) and knowledge bases, have been created and used for various fields. In these LOD and knowledge bases, that a fact holds is may be attested from the knowledge that stores the fact. It may be said that the stored knowledge represents a constraint to be satisfied by the fact in the domain corresponding to the knowledge.

Using this idea, the learning apparatus 10 extracts transfer data. For example, it is assumed that knowledge is given to the source domain and the target domain. When there is an attestation based on knowledge in each domain for teacher data (input/output relation <x, y>), the attestation is a constraint that the teacher data (input/output relationship <x, y>) in the domain that gave the attestation is required to satisfy. The attestation for the input/output relationship <x, y>is an attestation, derived from domain knowledge, in which the input x appears in the individual term part of the premise and the output y appears in the individual term part of the conclusion.

Data (input/output relationship <x, y>) having an attestation similar to the attestation pair for the teacher data in the corresponding domain is a transfer candidate as data satisfying the same constraint as the teacher data. When the number of pieces of teacher data is small, the data in the target domain having the same type of attestation as the teacher data is also added to the teacher data. The constraint that is the attestation pair is a basis (explanation) in which data that is not teacher data is regarded as transfer data.

The source domain and the target domain will, be described. The source domain is learning data for distinguishing between the first label and the second label. For example, the source domain is a cat image and a chicken image, and is learning data for distinguishing between the cat and the chicken. The learning machine may distinguish between the cat and the chicken by learning the learning data of the source domain. On the other hand, the target domain is learning data for distinguishing between the first label and the third label. For example, the target domain is a cat image and a dog image, and is learning data for distinguishing between the cat and the dog. The learning machine may discriminate between the cat and the dog by learning the learning data of the target domain. For example, the image of the cat in the source domain has characteristics for distinguishing between the chicken and the cat, but it may not be said that the image is suitable for distinguishing between the dog and the cat. As a result, when the cat image of the source domain is transferred to the cat image of the target domain, learning for distinguishing between the dog and the cat may deteriorate. The learning data is not limited to animal images and varies depending on the content to be learned. For example, the learning data may be as sports photographs, real estate images, gravure photographs, nail images, denture images, medical images, equipment maintenance images, and time series data such complaints.

For example, as illustrated in FIG. 1, the learning apparatus 10 holds knowledge information of a teacher data group (source domain) included in the source identification device, and knowledge information of a teacher data group included in the target identification device (learning apparatus 10). The domains of the source and the target are the same.

The learning apparatus 10 performs a target extension using the target knowledge information, and identifies the target data having an attestation similar to the attestation of the teacher data with the target knowledge. Subsequently, the learning apparatus 10 identifies the target data having the attestation even with the source knowledge among the identified target data. The learning apparatus 10 performs source extension using the source knowledge information, and identifies source data having the similar attestation to the target data having attestation even with the source knowledge among the source data.

The learning apparatus 10 merges the source data (source domain teacher data) identified in this way and the target teacher data into learning data. As a result, the learning apparatus 10 may extract useful transfer data without performing clustering or trial machine learning, and may shorten the extraction time.

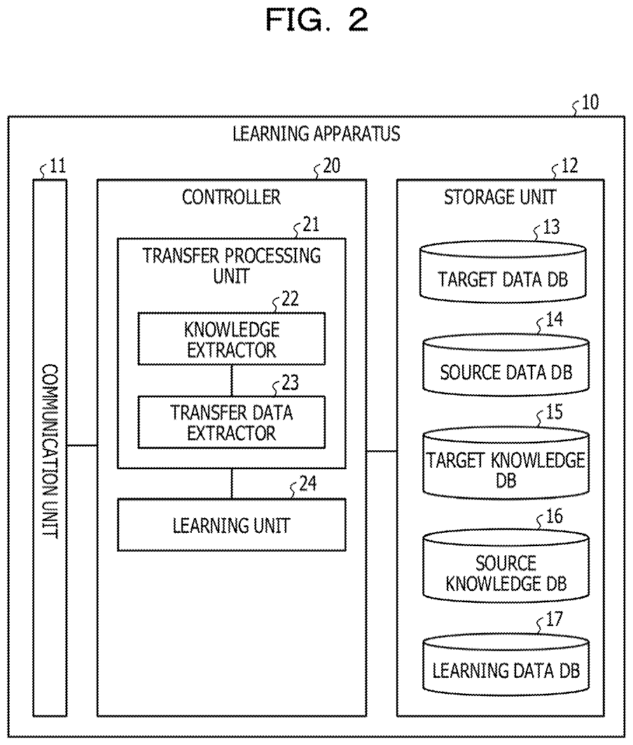

FIG. 2 is a functional block diagram illustrating a functional configuration of the learning apparatus 10 according to the first embodiment. As illustrated in FIG. 2, the learning apparatus 10 includes a communication unit 11, a storage unit 12, and a controller 20.

The communication unit 11 is a processing unit that controls communication with other devices, and is, for example, a communication interface. For example, the communication unit 11 transmits an instruction to start processing from a management terminal (not illustrated), send the determination result of transfer data to the management terminal, and receives, for example, knowledge information of the source domain from a source identification device (not illustrated).

The storage unit 12 is an example of a storage device that stores programs executed by the controller 20 and various data, and is, for example, a memory or a hard disk. For example, the storage unit 12 stores a target data DB13, a source data DB14, a target knowledge DB15, a source knowledge DB16, and a learning data DB17.

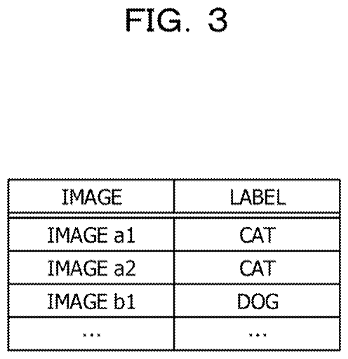

The target data DB13 is a database that stores teacher data of the target domain that is a target of transfer learning. FIG. 3 is a diagram illustrating an example of information stored in the target data DB13. As illustrated in FIG. 3, the target data DB13 stores “image and label” in association with each other. The “image” stored here indicates image data which is an example of teacher data to be learned, and “label” indicates a label set in the image data. In the example of FIG. 3, the label “cat” is set for an image a1, and the label “dog” is set for an image b1.

The source data DB14 is a database that stores teacher data of the source domain that is a source of transfer learning. The source data DB14 stores “image and label” in association with each other as in FIG, 3. For example, the source data DB14 stores data in which the label “cat” is set for an image j.

The target knowledge DB15 is a database that stores knowledge information, of the target domain, which is domain knowledge. For example, target knowledge DB15 is knowledge that may be identified from the relationship of each piece of teacher data of the target domain, and the learning apparatus 10 may automatically determine and acquire it, or the administrator may set it.

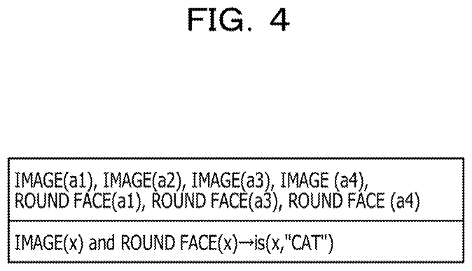

FIG. 4 is a diagram illustrating an example of information stored in the target knowledge DB15. As illustrated in FIG. 4, the target knowledge DB15 stores “image (a1), image (a2), image (a3), image (a4), round face (a1), round face (a3), and round face (a4)”, “image (x) and round face (x)→is (x, “cat”)”, and the like.

The source knowledge DB16 is a database that stores knowledge information, of the source domain, which is domain knowledge. For example, the source knowledge DB16 is knowledge that may be identified from the relationship of each piece of teacher data of the source domain. It may be acquired from the identification device of the source domain, or may be set by the administrator.

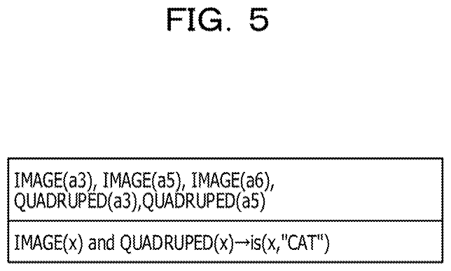

FIG. 5 is a diagram illustrating an example of information stored in the source knowledge DB16. As illustrated in FIG. 5 the source knowledge DB16 stores “image (a3), image (a5), image (a6), quadruped (a3), and quadruped (a5)”, “image (x) and quadruped (x)→ is (x)→ is (x, “Cat”)”, and the like.

The learning data DB17 is a database that stores teacher data to be learned. For example, the learning data DB17 stores teacher data obtained by transfer learning by the controller 20 to be described later.

The controller 20 is a processing unit that controls the entire learning apparatus 10, and is, for example, a processor. For example, the controller 20 includes a transfer processing unit 21 and a learning unit 24. The transfer processing unit 21 and the learning unit 24 are an example of an electronic circuit such as a processor and an example of a process to be executed by the processor.

The transfer processing unit 21 includes a knowledge extractor 22 and a transfer data extractor 23, and is a processing unit that extracts learning data from the source domain by transfer learning.

The knowledge extractor 22 is a processing unit that extracts knowledge of each domain. For example, the knowledge extractor 22 extracts knowledge information from the target knowledge DB15 and the source knowledge DB16, and outputs the knowledge information to the transfer data extractor 23.

For example, the knowledge extractor 22 refers to the target knowledge DB15, extracts, as the target knowledge, “the image (a1), the image (a3) and the image (a4) are image data corresponding to the round face, and the image data and the image data of the round face is the image data of “cat””, and outputs it to the transfer data extractor 23.

The knowledge extractor 22 refers to the source knowledge DB16, extracts, as the target knowledge, “image (a3) and image (a5) are image data corresponding to the quadruped, and the image data and the image data of the quadruped is the image data of “cat””, and outputs it to the transfer data extractor 23.

The transfer data extractor 23 acquires target learning data input to the target learning machine so as to distinguish between the first label and the third label. The transfer data extractor 23 acquires source learning data input to the source learning machine so as to distinguish between the first label and the second label when the number of pieces of learning data of the first label of the target learning data is less than a preset number, compared with that of the third label of the target learning data. The transfer data extractor 23 extracts learning data satisfying the constraint identified from the same learning data indicating the first label of the target and the source from the acquired source learning data.

For example, the transfer data extractor 23 is a processing unit that extracts the target learning data from the source data using the source domain knowledge and the target domain knowledge. For example, the transfer data extractor 23 extracts the source knowledge that is image data belonging to the source domain, and that has, out of the image data, the first data associated with the first label (for example, cat) and the second data associated with the second label (for example, chicken). The transfer data extractor 23 extracts the target knowledge that is image data belonging to the target domain and that has, out of the image data, the third data associated with the first label (for example, cat) and the fourth data associated with the third label (for example, dog).

The transfer data extractor 23 identifies the same data from the first data and the third data, and identifies, using the rule set for each domain, the first constraint in which the first data in the source domain indicates the characteristic (for example, four legs) of the first label with respect to the same data identified. The transfer data extractor 23 identifies the second constraint in which the third data in the target domain indicates the characteristic (for example, round face) of the first label with respect to the same data identified. The transfer data extractor 23 extracts the data having the first constraint identified from the source domain, extracts the data having the second constraint identified from the target domain, and when the same data is included in the extracted data, sets the extracted data having knowledge identified from the source domain as target learning data.

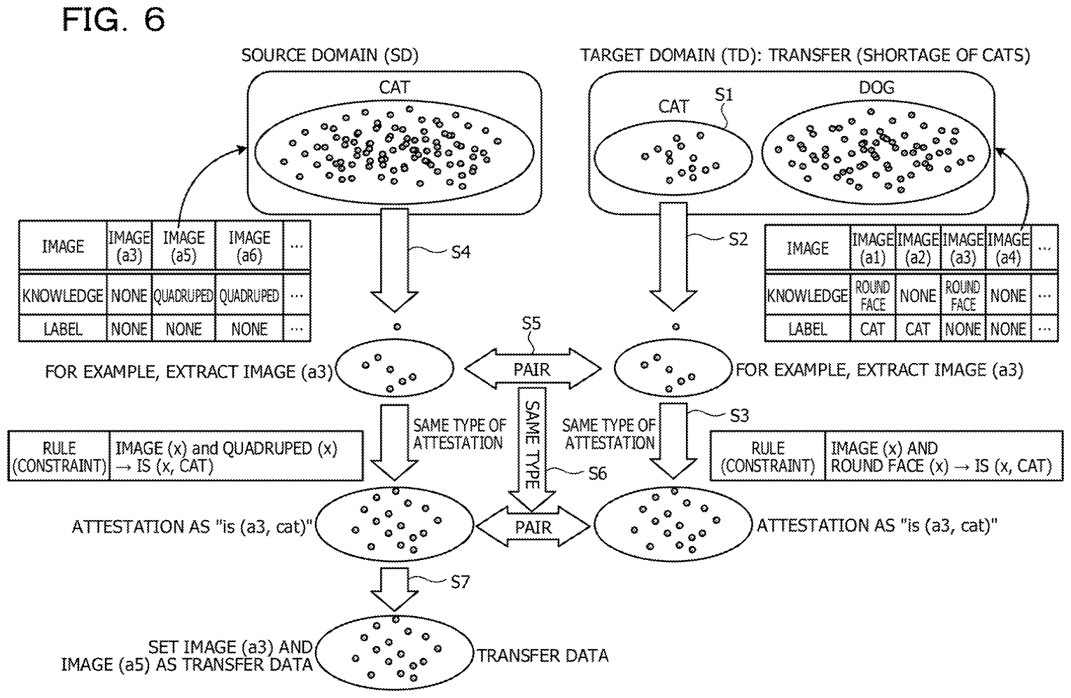

The extraction of transfer data will be specifically described. FIG. 6 is a diagram for explaining an overall example of transfer data extraction. The source learning data and the target learning data will be described. The source learning data includes at least the image (a3), the image (a5), and the image (a6). The transfer data extractor 23 acquires information from the source knowledge DB16 and associates the knowledge with the label of the image (a3), the image (a5), and the image (a6). As a result, it may be seen that knowledge and a label are unknown with respect to the image (a3). It may be seen that it is possible to identify the knowledge that is the quadruped and the label is unknown with respect to the image (a5) and the image (a6).

On the other hand, the target learning data includes at least the image (a1), the image (a2), the image (a3), and the image (a4). The transfer data extractor 23 acquires information from the target knowledge DB15, and associates the knowledge with the label of the image (a1), the image (a2), the image (a3), and the image (a4). As a result, with respect to the image (a1), it is possible to identify the knowledge that is the round face, and it is possible to identify the label that is the cat. With respect to the image (a2), it is understood that the knowledge is unknown, and it is possible to identify the label that is the cat. It may be seen that it is possible to identify the knowledge that is the round face and that the label is unknown with respect to the image (a3). It may be seen that the knowledge and the label are unknown with respect to the image (a4).

As illustrated in FIG. 6, it is assumed that the image data of the dog and the image data of the cat, which are teacher data of the target domain, are held, but the cat teacher data is insufficient. For example, the transfer data extractor 23 identifies learning data of the first label and the second label that constitute the target data. For example, the transfer data extractor 23 identifies learning data of a cat image and a dog image constituting the target data. The transfer data extractor 23 acquires learning data of the first label from the first label and the third label that constitute source learning data when the number of pieces of the data of the first label is less than a preset number, compared with the number of pieces of the data of the second label. For example, the transfer data extractor 23 determines acquisition of learning data of the cat image from the chicken image and the cat image constituting the source learning data when the number of pieces of the cat image data is less than a preset number, compared with the number of pieces of the dog image data (S1).

Subsequently, the transfer data extractor 23 of the learning apparatus 10 generates an attestation whose conclusion is the relationship (cat image) which is the same as the teacher data of the target. For example, at least one image is extracted from the target learning data, and an attestation which is the conclusion based on the extracted image and knowledge is generated. For example, the image (a3) is extracted from the target learning data. Next, based on the image (a3) and the rule of “image (x) and round face (x)→ is (x, “cat”)”, the attestation whose conclusion is that “image (a3) is a cat” is generated (S2). The transfer data extractor 23 generates an attestation set that is the same type as the teacher data in the target (S3). For example, the transfer data extractor 23 generates the same attestation set as “image (x) and round face (x) cat”.

On the other hand, the transfer data extractor 23 refers to the source data DB14 and the source knowledge DB16, and extracts the image data of the cat corresponding to the attestation of the cat in the source among the source data. The transfer data extractor 23 extracts learning data satisfying the constraint identified from the same learning data indicating the cat image of the target and the source from among the source learning data. For example, at least one image is extracted from the target learning data, and an attestation which is the conclusion based on the extracted image and knowledge is generated. For example, the image (a3) is extracted from the source learning data. Next, based on the image (a3) and the rule of “image (x) and quadruped (x)→ is (x, “cat”)”, the attestation whose conclusion is that “the image (a3) is a cat” is generated (S4). The transfer data extractor 23 determines that the target attestation generated in S2 and the source attestation (attestation of the cat) generated in S4 are paired (S5), and generates the source attestation that is paired with and is the same type as the attestation set generated in S3 (S6). For example, the transfer data extractor 23 generates the attestation set that is the same type as the attestation of the source cat among the source data.

Thereafter, the transfer data extractor 23 extracts the image data from the same type of attestation set in the source, transfers it to the target learning data as transfer data, and stores it in the learning data DB17. As a result, the transfer data extractor 23 may make up for learning data (cat teacher data) that is insufficient in the target. For example, the image (a3) and the image (a5) may be identified as the transfer dab.

The image extracted from the target learning data in S2 and the image extracted from the source learning data in S4 are required to be the same data. For example, the source learning data and the target learning data partially overlap with each other. For example, when the image extracted from the target learning data in S2 is the image (a3) and the image extracted from the target learning data in S4 is the image (a1), attestations forming the pair does not hold in S5. In this case, new learning data is extracted from the target learning data and the source learning data.

Returning to FIG. 2, the learning unit 24 is a processing unit that performs machine learning using learning data including transfer data stored in the learning data DB17. The machine learning executed by the learning apparatus 10 may include, in addition to general machine learning, various neural networks such as a recurrent neural network (RNN) and a convolutional neural network (CNN).

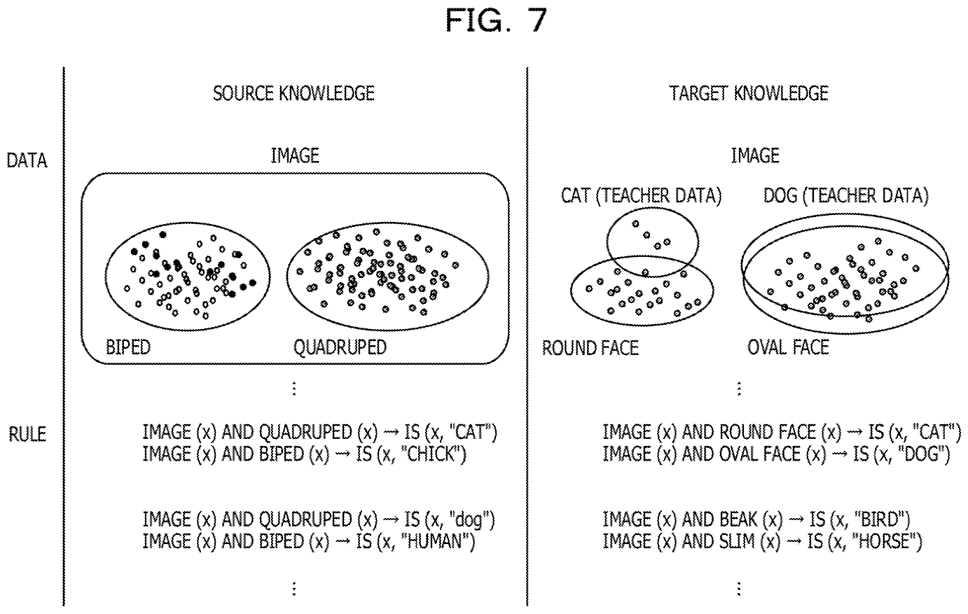

Next, a specific example of transfer data extraction will be described with reference to FIGS. 7 to 12. FIG. 7 is a diagram for explaining a premise of target knowledge and source knowledge. As illustrated in FIG. 7, the knowledge of the source held by the learning apparatus 10 includes data and rules. The data includes image data of biped animals and the like and image data of quadruped animals and the like. The knowledge includes, as an example, “image (x) and quadruped (x)→ is (x, “cat”)” indicating the rule (constraint) that the image data of the quadruped is a cat, “image (x) and bipod (x)→ is (x, “chicken”)” indicating the rule that the image data of the biped is a chicken, “image (x) and quadruped (x)→ is (x, “dog”)” indicating the rule that the image data of the quadruped is a dog, and “image (x) and biped (x)→ is (x, “human”)” indicating the rule that the image data of the biped is a person.

Similarly, the knowledge of the target held by the learning apparatus 10 includes data and rules. The data includes the image data of animals of the round face and the like, and the image data of animals of the oval face and the like, which include the image data of the cat that is teacher data and the image data of the dog that is teacher data. The knowledge includes, as an example, “image (x) and round face (x)→ is (x, “cat”)” indicating the rule that the image data of the round face is a cat, “image (x) and oval face (x)→ is (x, “dog”)” indicating the rule that the image data of the oval face is a dog, “image (x) and beak (x)→ is (x, “bird”)” indicating the rule that the image data with a beak is a bird, and “image (x) and slim (x)→ is (x, “horse”)” indicating the rule that slim image data is a horse.

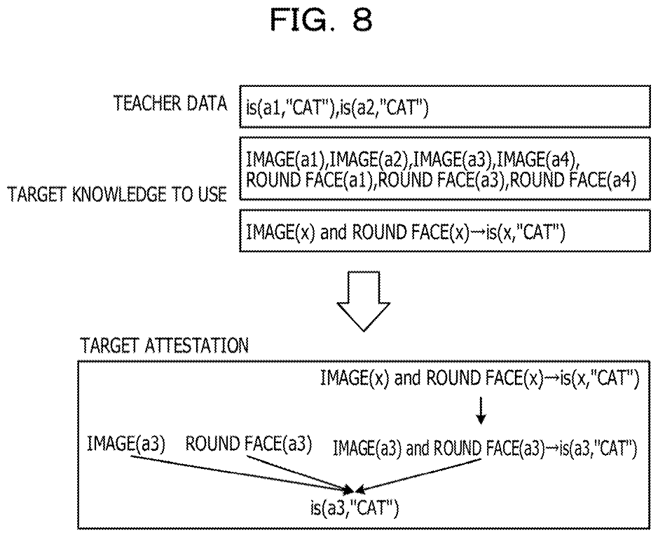

In such a state, the transfer data extractor 23 of the learning apparatus 10 detects an image having an attestation, in the target, whose conclusion is the same relationship (cat image relationship) as the teacher data, and generates the target attestation. FIG. 8 is a diagram for explaining generation of the target attestation. With respect to the image (a3) and the image (a4), the transfer data extractor 23 may make an attestation whose conclusion is “is (a3, “cat”)” and “is (a4, “cat”)” which are the same relationship as the teacher data “is (a1, “cat”)” using the knowledge of the target domain.

For example, as illustrated in FIG. 8, the transfer data extractor 23 generates the rule “image (a3) and round face (a3)→is (a3, “cat”)” indicating that the image (a3) of the round face is a cat from the rule “image (x) and round face (x)→ is (x “cat”)” that is the knowledge indicating that the image data of the round face is a cat and the knowledge that image (a3) is the image data of the round face. As a result, the transfer data extractor 23 generates the rule “is (a3, “cat”)”. For example, the transfer data extractor 23 generates the attestation of “is (a3, “cat”)” that is the same type as the attestation of the teacher data “is (a1, “cat”)”.

The fact that the attestations p1 and p2 are the same type means that an attestation obtained by replacing all individual terms with the attestation p1 with another individual term becomes the attestation p2. For example, the fact that the attestation p1 and the attestation p2 are the same type means that a predicate that appears in one attestation tree appears in the other.

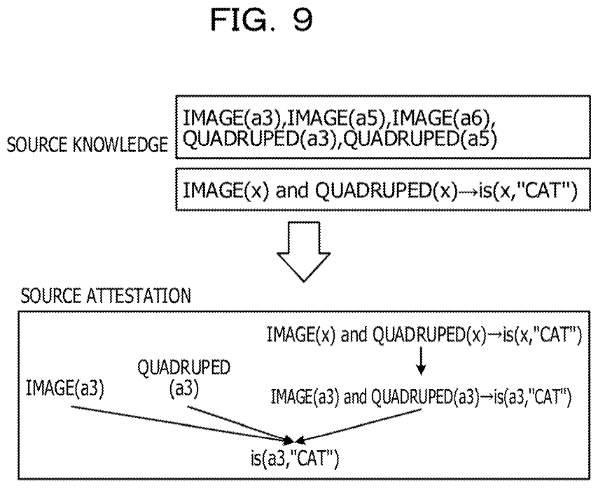

Similarly, the transfer data extractor 23 of the learning apparatus 10 constructs the source attestation that is the same type as the attestation in the target. FIG. 9 is a diagram for explaining generation of the source attestation. With respect to the image (a3), the transfer data extractor 23 may make an attestation whose conclusion is “is (a3, “cat”)” which is the same as the teacher data in the target using the knowledge of the source.

For example, as illustrated in FIG. 9, the transfer data extractor 23 generates the rule “image (a3) and quadruped (a3)→ is (a3, “cat”)” indicating that the image (a3) of the quadruped is a cat from the rule “image (x) and quadruped (x)→ is (x, “cat”)” indicating that the image data of the quadruped is a cat and the knowledge that the image (a3) is the image data of the quadruped. As a result, the transfer data extractor 23 generates the relationship “is (a3, “cat”)”. For example, the transfer data extractor 23 generates the attestation of “is (a3, “cat”)” in the source which is the same (type of the) relationship as the relationship “is (a3, “cat”)” in the target.

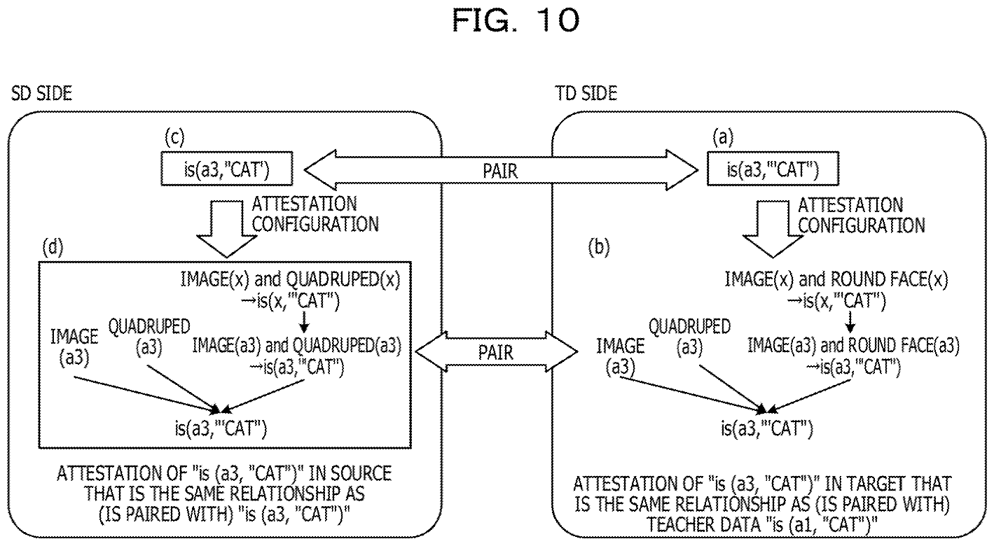

Subsequently, the transfer data extractor 23 of the learning apparatus 10 detects (finds) the attestations that form the pair between the target and the source. FIG. 10 is a diagram for explaining detection of the attestations that form the pair between the target and the source. As illustrated in FIG. 10, the transfer data extractor 23 generates, for the target domain (TD) as described in FIG. 8, generates the attestation of “is (a3, “cat”)” that is the same type as the attestation of teacher data “is (a1, “cat”)” by the relationship (a) “is (a3, “cat”)” and the attestation configuration (b). Similarly, as described in FIG. 9 for the source domain (SD), the transfer data extractor 23 generates the attestation of the relationship “is (a3, “cat”)” that is the same as the target relationship “is (a3, “cat”)” by relationship (c) “is (a3, “cat”)” and the attestation configuration (d).

The transfer data extractor 23 identifies that the target relationship (a) and the source relationship (c) form the pair relationship in the sense that the two relationships are for the different regions but are the same relationship. Similarly, the transfer data extractor 23 identifies that the target attestation configuration (b) and the source attestation configuration (d) form the pair attestations in the sense that the two attestation configurations are for the different regions but are the attestations with the same conclusion. In this way, the transfer data extractor 23 identifies the attestations and the relationships which form their respective pairs between the target and the source having different domains.

Thereafter, the transfer data extractor 23 of the learning apparatus 10 detects the same type of attestation in the source. For example, in FIG. 10, the transfer data extractor 23 identifies the relationship in which the source attestation that is paired with and is the same as the target attestation may be constructed.

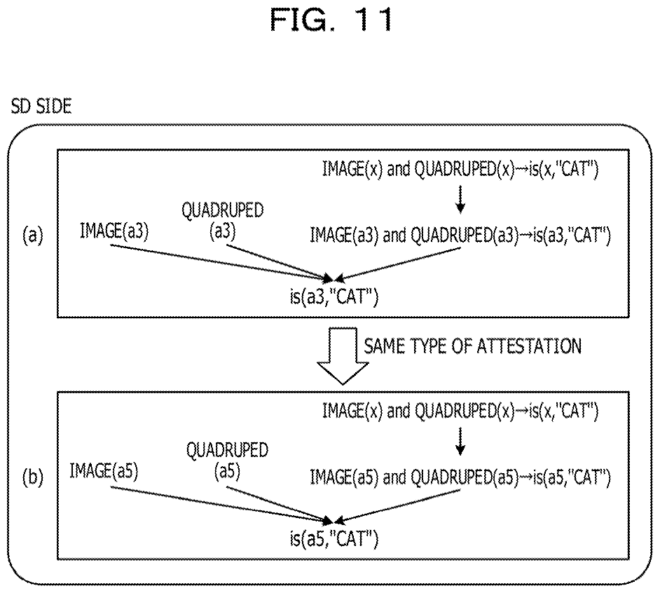

FIG. 11 is a diagram for explaining the detection of the same type of attestation in the source. The transfer data extractor 23 generates the rule “image (a5) and quadruped (a5)→ is (a5, “cat”)” indicating that the image (a5) of the quadruped is a cat from the rule “image (x) and quadruped (x)→ is (x, “cat”)” indicating that the image data of the quadruped is a cat and the knowledge that the image (a5) is the image data of the quadruped. As a result, as illustrated in FIG. 11, the transfer data extractor 23 generates the relationship (b) “is (a5, “cat”)” that is the same type as the relationship (a) “is (a3, “cat”)”.

Thereafter, the transfer data extractor 23 of the learning apparatus 10 extracts transfer data from the source data group based on the relationship and the attestation generated in the source. For example, the transfer data extractor 23 transfers data corresponding to the relationship (a) or the relationship (b) illustrated in FIG. 11 to the target as transfer data.

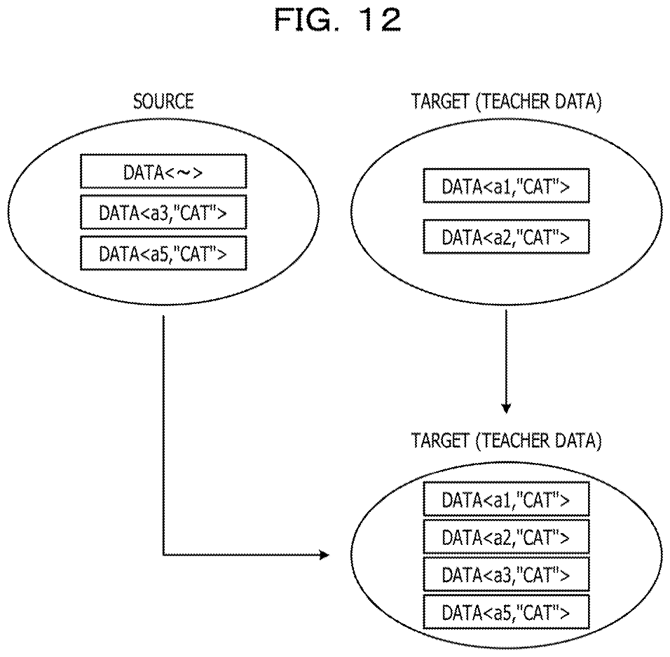

FIG. 12 is a diagram illustrating extraction of the transfer data. As illustrated in FIG, 12, the transfer data extractor 23 extracts, as the transfer data, data <a3, “cat”> corresponding to the relationship (a) “is (a3, “cat”)”, and data <a5, “cat”> corresponding to the relationship (b) “is (a5, “cat”)” among the source data group. For example, the transfer data extractor 23 extracts, as the transfer data, data <a3, “cat”> that satisfies the constraint identified by relationship (a), and data <a5, “cat”> corresponding to “is (a5, “cat”)” that satisfies the constraint identified by the relationship (b) among the source data group.

For example, the transfer data extractor 23 extracts, as the transfer data, data <a3, “cat”> corresponding to the relationship “is (a3, “cat”)” having the same type of attestation as the teacher data in the source and having the attestation also in the target. The transfer data extractor 23 extracts, as transfer data, the data <a5, “cat”> corresponding to the relationship “is (a5, “cat”)” having the attestation which is the same type as the attestation of the relationship “is (a3, “cat”)” in the source.

As a result, the learning unit 24 may learn, as the teacher data, the data obtained by adding the data <a3, “cat”> and the data <a5, “cat”> to the data <a2, “cat”> and the data <a1, “cat”>, which were originally stored.

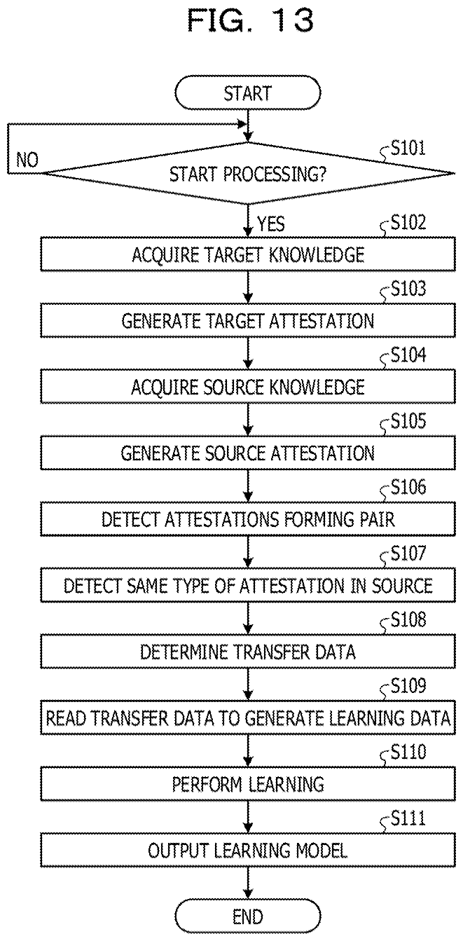

Next, a series of flow and detailed flow with respect to the processing from the transfer data extraction to before learning will be described. FIG. 13 is a flowchart illustrating a series of flow from the transfer data extraction process to the learning process. As illustrated in FIG. 13, knowledge information of the target domain and knowledge information of the source domain are input, and when the process is disclosed (S101: Yes), the transfer data extractor 23 of the learning apparatus 10 acquires the target knowledge from the target knowledge DB15 (S102), and generates (constructs) the target attestation (S103). The transfer data extractor 23 acquires the source knowledge from the source knowledge DB16 (S104), and generates (constructs) the source attestation (S105).

Subsequently, the transfer data extractor 23 detects the attestations that form the pair between the target and the source (S106), and detects the same type of attestation in the source (S107). Thereafter, the transfer data extractor 23 determines transfer data from the source data group based on the attestations that form the pair between the target and the source, the same type of attestation in the source, and the like (S108).

The transfer data extractor 23 reads the determined transfer data from the source data DB14, generates learning data together with the data stored in the target data DB13, and stores it in the learning data DB17 (S109).

Thereafter, the learning unit 24 performs machine learning using the learning data stored in the learning data DB17 (S110), generates the learned learning model, and outputs it to the storage unit 12 and the like (S111).

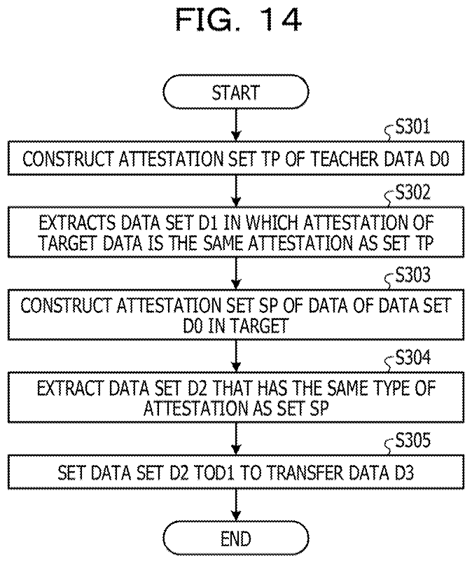

FIG. 14 is a flowchart of a detailed flow of the transfer data extraction process according to the first embodiment. As illustrated in FIG. 14, the transfer data extractor 23 uses the target knowledge information TK to construct an attestation set TP of teacher data D0 (S301).

Subsequently, the transfer data extractor 23 extracts a data set D1 in which the attestation of the target data obtained by using the knowledge information TK of the target domain in the target is the same type of attestation as the set TP (S302).

The transfer data extractor 23 constructs an attestation set SP of the data of the data set D0 using the source knowledge information SK (S303). Subsequently, the transfer data extractor 23 extracts, from the set D1 and the source data, a data set D2 having the attestation which is the same type as the attestation of the set SP using the source knowledge SK (S304). Thereafter, the transfer data extractor 23 sets the data set “D2-D1” as transfer data D3 (S305).

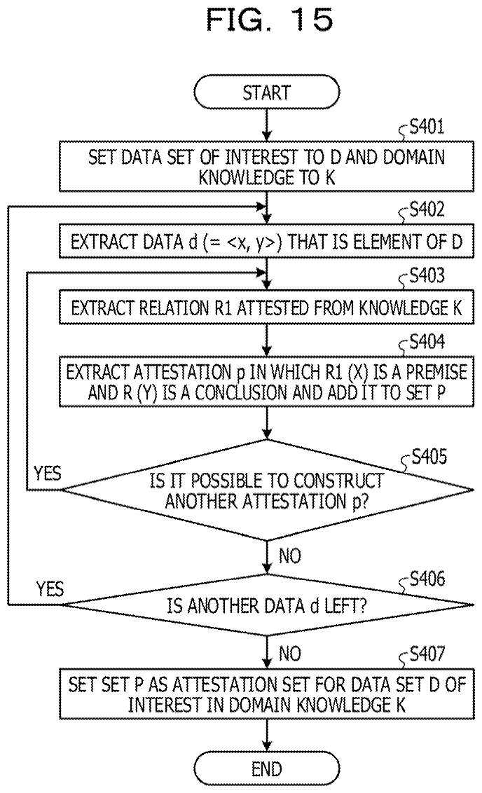

FIG. 15 is a flowchart of a detailed flow of a configuration process of an attestation set according to the first embodiment. As illustrated in FIG. 15, the transfer data extractor 23 sets a data set of interest as D(={<x, y>), and domain knowledge (knowledge information) as K (S401).

Subsequently, the transfer data extractor 23 extracts data d(={<x, y>) that is an element of the data set D (S402). The transfer data extractor 23 extracts the relationship R1 attested from the knowledge K based on the fact R1 (x) which is the vector x portion in which the input x is composed of a constant (S403).

The transfer data extractor 23 extracts an attestation p in which R1 (X) is a premise, and R (Y) is a conclusion based on the vector Y portion in which the output y is composed of a constant and the fact R2 (Y) to add it to a set P (S404).

The transfer data extractor 23 repeats S403 and subsequent steps when another attestation p may be constructed (S405: Yes). On the other hand, when the another attestation p may not be constructed (S405: No), the transfer data extractor 23 determines whether another piece of data d is left (S406).

When the another data d is left (S406: Yes), the transfer data extractor 23 repeats S402 and subsequent steps. On the other hand, when no another data d is left (S406: No), the transfer data extractor 23 sets the set P as an attestation set for the data set D of interest in the domain knowledge k (S407).

As mentioned above, in the learning apparatus according to the first embodiment, the learning apparatus 10 may extract useful transfer data without performing clustering or trial machine learning, and may shorten the extraction time. The learning apparatus according to the first embodiment may clearly indicate what conditions the teacher data and the transfer data used for transfer learning satisfy by the attestation of the transfer data in the source domain, and the attestation of the teacher data in the target domain. As a result, the assumption that “the source domain and target domain are similar to each other but slightly different from each other” may be given as an attestation pair in a human-readable form. For this reason, it is possible to check in advance that data unintended by the user is mixed.

While the embodiments of the present disclosure has been described, the present disclosure may be implemented in various different forms other than the embodiment described above.

For example, in the first embodiment, an example in which transfer data is extracted from one source and transfer learning is performed has been described. However, the present disclosure is not limited to this. For example, the transfer data extractor 23 of the learning apparatus 10 may cause the user to select one source from knowledge of a plurality of sources.

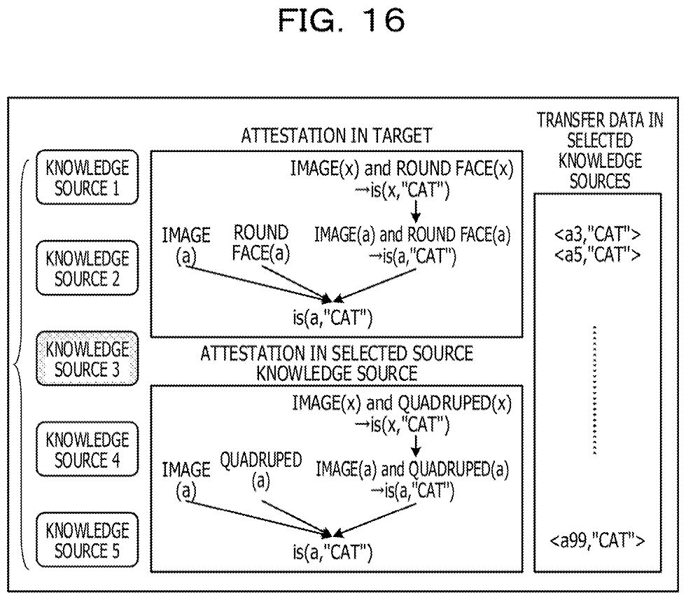

FIG. 16 is a diagram for explaining an example of selecting a source from a plurality of knowledge sources. The learning apparatus 10 generates the attestation in the target, the attestation in the source, and the transfer data to be extracted for each of knowledge 1 to knowledge 5 that are the object of the source using the same method as in the first embodiment. As illustrated in FIG. 16, the learning apparatus 10 displays a button for displaying each knowledge source in a selectable manner, and a selection screen for displaying the attestation in the target, the attestation in the source, and the transfer data to be extracted which are specified for the knowledge source being selected.

By selecting each knowledge source on the screen illustrated in FIG. 16 the user may browse the attestation configuration and transfer data for the selected knowledge source, and select a knowledge source which is used as the source. For example, knowledge sources 1, 2, 3, 4, and 5 are displayed. When the user selects the knowledge source 3, the attestation of the selected knowledge source 3 is displayed as an “attestation in the source knowledge source being selected”. When the user selects the knowledge source 3 as transfer data, it is displayed as “transfer data in the knowledge source being selected”. In this way, the learning apparatus 10 may cause the user to browse the attestation in the target as an explanation of the teacher data, and may support selection of which knowledge source is the source by causing the user to browse the attestation in the source selected by the user as an explanation of the transfer data.

In the above example, an example of extracting, as the transfer data, learning data that satisfies the source attestation that is paired with the target attestation, and learning data that satisfies a source attestation which is the same type as the source attestation is described, but the present disclosure is not limited thereto,. For example, when the number of pieces of target learning data (teacher data) is equal to or greater than the first threshold and less than the second threshold, it is possible to extract, the as transfer data, only learning data satisfying the source attestation that is paired with the target attestation. When the number of pieces of target learning data (teacher data) is less than the first threshold, it is possible to extract, the as transfer data, learning data satisfying the above each source attestation.

Processing procedures, control procedures, specific names, and information containing various kinds of data and parameters indicated in the specification and the drawings may be changed in any manner unless otherwise specified. The specific examples, distributions, numerical values, and the like described in the embodiments are merely examples and may be arbitrarily changed.

The constituent elements of the apparatuses illustrated in the drawings are functionally conceptual ones and do not necessarily have to be physically configured as illustrated. Specific forms of distribution and integration of the devices are not limited to those illustrated in the drawings. All or some of the devices may be functionally or physically distributed or integrated in any unit based on various loads, usage statuses, or the like. All or some of the processing functions performed by the devices may be implemented by a central processing unit (CPU) and a program analyzed and run by the CPU or may be implemented by a hardware device using wired logic coupling.

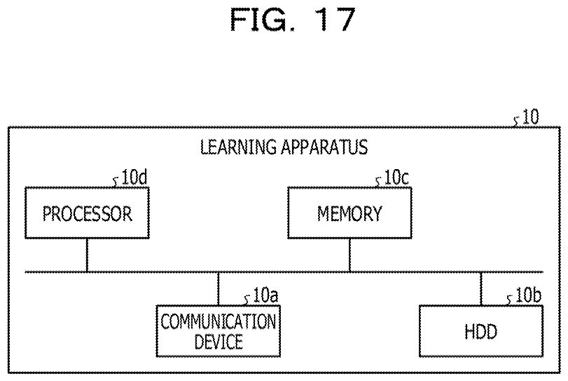

FIG. 17 is a diagram describing an example of a hardware configuration. As illustrated in FIG. 17, the learning apparatus 10 includes a communication device 10a, a hard disk drive (HDD) 10b, a memory 10c, and a processor 10d. The components illustrated in FIG. 17 are coupled to each other by, for example, a bus.

The communication device 10a is, for example, a network interface card and communicates with a server. The HDD 10b stores a program and DBs that implement functions illustrated in FIG. 2.

The processor 10d reads, from the HDD 10b or the like, a program for executing substantially the same processes as those of the processing units illustrated in FIG. 2 and loads the program into the memory 10c, thereby executing a process of performing the functions described with reference to FIG. 2 and so on. The processes implement the same functions as that of the processing units included in the learning apparatus 10. For example, the processor 10d reads, from the HDD 10b or the like, a program having the same functions as those of the transfer processing unit 21, the learning unit 24, and the like. The processor 10d executes a process for executing the same processing as that of the transfer processing unit 21, the learning unit 24, and the like.

As described above, the learning apparatus 10 functions as an information processing apparatus that implements a learning method by reading and executing the program. The learning apparatus 10 may also implement the same functions as those of the embodiments described above by reading the program from a recording medium with the use of a medium reading device and executing the read program. The program described in other embodiments is not limited to a program that is run by the learning apparatus 10. For example, the disclosure is applicable to the case in which another computer or server executes the program or the case in which these cooperate to execute the program.

The program may be distributed via a network such as the Internet. The program may be recorded on a computer-readable recording medium such as a hard disk, a flexible disk (FD), a compact disc read-only memory (CD-ROM), a magneto-optical disk (MO), a digital versatile disc (DVD), or the like, and may be executed after being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a illustrating of the superiority and inferiority of the Invention. Although one or more embodiments of the present invention have been described in detail, it should be understood that the various changes, substitutions, and alterations could be made hereto without departing from the spirit and scope of the invention.

What is claimed is:

1. A transfer learning method executed by a computer, the method comprising:
selecting learning data that satisfies a constraint identified from target learning data in a target domain and source learning data in a source domain for a transfer learning; and
extracting the selected learning data among the source learning data as transfer data to be used as the target learning data.

2. The transfer learning method according to claim, wherein the method further comprising:
acquiring target learning data input to a target learning machine so as to distinguish between a first label and a third label;
acquiring source learning data input to a source learning machine so as to distinguish between the first label and a second label when a difference between the number of pieces of data of the third label of the target learning data and the number of pieces of learning data of the first label of the target learning data is larger than a preset number;
extracting, from the acquired source learning data, learning data that satisfies a constraint identified from the same learning data indicating the first label of the target and the source; and
performing learning based on the extracted learning data and the target learning data.

3. The transfer learning method according to claim 1, wherein
the selecting includes generating a first constraint using first knowledge information given to the target domain including the target learning data, and
the extracting includes extracting the transfer data from learning data constructing a constraint that is paired with and is the same type as the first constraint among constraints generated using second knowledge information given to the source domain including the source learning data.

4. The transfer learning method according to claim, wherein the method further comprising:
detecting, from the target learning data, a second constraint whose conclusion is the same as a conclusion of the first constraint using the first knowledge information in the target;
generating, from the source learning data, a third constraint that is the same type as the second constraint in the target;
detecting, from the source learning data, a fourth constraint that is the same type as the third constraint in the source; and
detecting learning data satisfying the third constraint or learning data satisfying the fourth constraint among the source learning data as the target learning data.

5. The transfer learning method according to claim 3, the method further comprising:
generating the first constraint in the target and same type constraint paired with the first constraint in the source and extracting the transfer data, for each of a plurality of knowledge sources; and
displaying a selection screen in which the knowledge source, the first constraint, the same type of constraint, and the transfer data are associated with each other.

6. The transfer learning method according to claim 5 executed by the computer, the method further comprising;
acquiring the transfer data associated with the each knowledge source selected on the selection screen from the selected knowledge source, and executing the transfer learning as learning data.

7. A learning apparatus, comprising:
a memory; and
a processor coupled to the memory and the processor configured to:
select learning data that satisfies a constraint identified from target learning data in a target domain and source learning data in a source domain for a transfer learning, and
extract the selected learning data among the source learning data as transfer data to be used as the target learning data.

8. A computer-readable recording medium having stored therein a program that causes a computer to execute a learning process, the learning process comprising:
selecting learning data that satisfies a constraint identified from target learning data in a target domain and source learning data in a source domain for a transfer learning; and
extracting the selected learning data among the source learning data as transfer data to be used as the target learning data.
